(19) United States
(12) Patent Application Publication
(10) Pub. No.: US 2011/0190124 A1
(43) Pub. Date: Aug. 4, 2011

(54) PROCESS FOR THE PREPARATION OF FERTILIZER AND SURFACTANT NATURAL COMPOSITIONS FOR WASHING, RECLAMATION AND CULTIVATION OF CONTAMINATED SOILS AND RELATED COMPOSITIONS

(76) Inventor: Domenico Terenzio, Fondi (LT) (IT)

(21) Appl. No.: 13/056,936

(22) PCT Filed: Jul. 27, 2009
(86) PCT No.: PCT/IT2009/000332

§ 371 Date: Apr. 20, 2011

(30) Foreign Application Priority Data
Jul. 29, 2008 (IT) RM2008A000407

(51) Int. Cl. C05F 11/02; C05D 9/02

(52) U.S. Cl. 504/101; 71/27; 71/24

(57) ABSTRACT

The present invention concerns a process for the preparation of fertilizer and surfactant natural compositions for washing, reclamation and cultivation of contaminated soils and said compositions based on Humoalginates obtained by reaction of fossil material, preferably leonardite, with alginic acid in alkaline medium.

The present invention concerns a process for the preparation of fertilizer and surfactant natural compositions for washing, reclamation and cultivation of contaminated soils and said compositions. In particular, the compositions according to the invention are based on Humoalginates obtained by reaction of fossil material, preferably leonardite, with alginic acid in alkaline medium.

Many commercially available fertilizer compositions are based on humates and\or humic acid extracts, generally extracted from leonardite, a humus fossil, similar to the coal characterized by high content of humic substances (humic and fulvic acids) with high degree of humification of contained organic carbon. However, these compositions present remarkable functionality problems, meaning quali-quantitative results on the crops, i.e. the same do not result in good application results.

Humic acids perform very important functions in the soil and plant. In the soil they bind to mineral nutritive elements, in particular phosphorus and iron, enhancing the assimilation by plants and preventing from insolubilization occurring in the presence of limestone high concentration. It is also known that humic acids enhance the degradation of phytodrugs and polluting substances of organic origin like dioxins. From the point of view of chemical nomenclature, dioxins are a class of organic heterocyclic compounds with a structure consisting of a ring with 4 carbon and 2 oxygen atoms. They represent a class of compounds including cancerogenic substances for humans and some of the most powerful toxic members from approximately 200 stable dioxins. Most known dioxins are polychlorinated dibenzodioxins, i.e. aromatic compounds with a structure consisting of 2 benzene rings bound through 2 oxygen atoms and containing one or more chlorine atoms Most toxic are isomers with chlorine at 2,3,7,8 positions. Most known among dioxins is TCDD (2,3,7,8-tetrachlorodibenzo-p-dioxin). Most polyhalo-dioxins are persistent organic pollutants, as for example PCDD (polychlorodibenzodioxins), PCDF (polychlorodibenzofurans), CO-PCB (coplanar polychlorobiphenyls).

Humic acids act as excellent natural surfactants suitable to wash, according to well established methods, soils polluted by heavy metals, hydrocarbons, pesticides and other wastes, allowing to restore all the biochemical conditions of the soil suitable to start or to resume a normal zootechnical activity being avoided any contamination potentially transmitted from the soil to growing cultivation and consequently to animals and again to the soil.

Humic acids promote the germination of seeds, the development and lengthening of roots and stimulate the development of plant tall parts (bud, flower, fruit). In order to increase the complexing power of the fertilizer based on humates and\or humic acids, U.S. Pat. No. 4,698,090 describes a process for the preparation of a liquid composition used in order to modify the plant growth wherein a leonardite based mineral is reacted with an organic chelating agent in aqueous medium at a temperature between 77° C. and 107° C. Among used chelating agents, metal or ammonium salts of hydroxy acids, as for example gluconic, glucaric, glutaric and glutamic acids or glutamines and organic synthetic chelating agents, as for example EDTA, are reported.

U.S. Pat. No. 4,786,307 describes a process for the preparation of liquid micronutritive compositions wherein the product resulting from extraction of the leonardite based material in water with a chelating agent, consisting of hydroxy acid salt, at pH>2.5, is combined with a metallic salt of micronutritive metal in presence of hydroxy acid, with successive addition of anhydrous ammonia to the reaction mixture in order to have pH values from 7.5 to 9.

However, synthetic chelating agents, as for example ethylene diamine tetraacetic acid, (EDTA), diethylenetriaminepentacetic acid (DTPA), ethylenediamine-N,N′-bis(2-hydroxyphenyl acetic) acid (EDDHA), result in vey high environmental impact because they are immediately leached in ground water and consequently accumulated in waters and foods.

WO 2004/110962 describes a process for the preparation of fertilizer compositions in solid or liquid form based on fossil materials having high content of humic acids, in particular leonardite, comprising the addition of water and gluconic acid and subsequent extraction of humic acid in the presence of an alkaline agent such as potassium or ammonium hydroxide up to pH>9.

GB2290290 describes a process for the preparation of a plant growth stimulating agent by reaction of marine algae and peat in alkaline medium under pressure and high temperature to extract a substantial amount of humates, alginates and nutrients. Therefore, GB2290290 concerns stimulating agents for the plant growth, both in liquid and solid form, i.e. products used in agriculture only in particular phonological phases of the plants (post-transplant in order to favour the root generation, flowering (in order to improve the fruit setting), critical thermal conditions in winter in order to accelerate the increase (with respect to plants particularly sensitive to low temperatures). The growth stimulating agents cannot be assimilated or confused with fertilizers. The latter in fact are consisting of high percentages of macro and microelements and/or organic substance, allowing to feed the cultivation during the whole cycle in addition to improve the pedological conditions from the chemical, physical and biological point of view, what a stimulating agent cannot do. The process described in GB2290290 involves the use of marine algae containing among hormonal substances, auxins, gibberellines and cytokynines, providing the formulations with an elevated stimulating activity for the plant growth, however their use is limited to minimal amounts for hectare (2-5 kg) and only and exclusively during cold periods. During warm periods of the year, the above mentioned substances create an immediate lengthening of the cells, unbalancing the growth of the plants and therefore the biochemical activities thereof. According to the process described in GB2290290, sodium carbonate (Na₂CO₃), which when dissolved in water results in a basic solution characterized by a very low extracting activity for humic substances contained within the peat and it is not suitable to extract alginic acid from the algae, is used. Moreover, alginic acid contained within the algae is combined with various elements as alginates, i.e. salts of alginic acid which are unable to complex, bind, chelate other elements or organic substances or minerals.

In the light of above it is therefore apparent the need to provide for new fertilizer compositions suitable to overcame the disadvantages of known compositions.

The author of the present invention has now prepared new fertilizer compositions based on complexes of humic and/or fulvic acid with alginic acid, below named Humoalginates, displaying a such high functionality to obtain quali-quantitative improvements in treated cultivations in comparison to currently known fertilizer compositions. The present invention provides moreover a process for the preparation of fertilizer compositions according to the invention to be used also as natural surfactants. The fertilizer compositions according to the invention do not comprise algae, therefore the same can be used in all climatic conditions and different areas of the world for all the year without any limitation. The process according to the invention allows humic substances to be extracted from fossil products with elevated content of biological origin highly moistened organic carbon, allowing stable and active humoalginic complexes to be produced. Further the use of alginic acid as complexing agent for macro and microelements allows to obtain a slow-release effect from fertilizers, to avoid the rain-out of the nutritive elements, to increase in a marked manner the soil water retention, to improve land cultivability, physical structure and aeration, to allow a nitrate marked reduction, to eliminate totally the use of synthetic, highly environmental impacting chelating agents (EDTA, EDDHA, etc.). This because the complex of humoalginic substances, created during the process of extraction of the humic substances from fossil material, allows stable and highly active molecules to be obtained (for example iron humoalginic complex), toxic substances in contaminated lands to be degraded and the normal pedological conditions for cultivation to be restored.

Particularly various experimentations showing remarkable advantages of the compositions according to the present invention in comparison to known fertilizer formulations, as for example humates and glucohumates, have been carried out. Humates use only potassium hydroxide or ammonium hydroxide or sodium hydroxide for the extraction of the humic substances from hunified fossils. Glucohumates use gluconic acid to better complex humic substances, as pre-treatment and successively make advantage of an alkaline product selected from potassium hydroxide and ammonium hydroxide as extracting agent. The significant quali-quantitative advantages of the compositions according to the present invention from the point of view of the functionality both on cultivations and soil can be synthesised as below:

a) highest absorption rapidity of macro- and microelements together with base Humoalginates or Humoalginates complexes purposely formulated with added substances;
b) marked improvement of biochemical activities of the soil and plants;
c) enhancement of endogenous protection of the plants, with reduction of the pesticides use;
d) remarkable reduction of mineral or synthetic fertilizer use, restoring of the soil fertility, reduction of environmental impact resulting from the indiscriminate use of synthetic fertilizers (as for example nitrates, phosphates);
e) increase of chlorophyll photosynthesis in plants and consequent increase in flower and fruit coloration;
f) reduction of irrigations, due to elevated water retention resulting from alginic acid;
g) highest chelating activity relating to macro- and microelements designed to plant nutrition;
h) remarkable increase of crop yields and quality.

Table 1 second reassumes successful results obtained using the compositions according to the present invention for different cultivation types.

(table 1 follows)

TABLE 1

| | Assessed | |
|---|---|---|
| | increased | |
| cultivations | productions | Notes |
| sugar beet | 12% | 20% increase sugar |
| | | polarization |
| salads | 25% | 7-8 day anticipated |
| | | harvesting |
| sunflower | 15% | 10% increase of oil yields |
| soya | 14% | 10% increase of oil yields |
| maize | 16% | |
| tomato | 20% | 8-10 day anticipated |
| | | harvesting |
| celery | 30% | 8-10 day anticipated |
| | | harvesting |
| radish | 12% | 3-6 day anticipated |
| | | harvesting |
| valerian | 10% | 3-5 day anticipated |
| | | harvesting |
| plum | 14% | 10-12 day anticipated |
| | | harvesting |
| kiwi | 15% | fruit homogenization and |
| | | storability improvement |
| banana | 12% | fruit homogenization and |
| | | storability improvement |
| strawberry | 16% | production homogenization, |
| | | 4-6 day anticipated |
| | | harvesting and greater |
| | | resistance to root fungine |
| | | infections |
| courgette | 20% | production homogenization, |
| | | 3-5 day anticipated |
| | | harvesting |
| french bean | 22% | production homogenization, |
| | | 4-7 day anticipated |
| | | harvesting |
| potatoes | 18% | |
| rape | 20% | |
| tea | 18% | |
| coffee | 16% | |
| cacao | 12% | Increase of theobromine |
| | | content |
| papaya | 13% | production homogenization, |
| | | 4-7 day anticipated |
| | | harvesting |
| rice | 14% | production homogenization, |
| | | product quality improvement |
| | | in a generalized manner |

The elevated complexing activity displayed by alginic acid has been proved to be remarkable higher than other organic acids and allows all the nutritive elements to be delivered to the plants in the best and balanced way, without losses or blocks, the contributions of fertilizing units to be optimized, to reduce the contributions in a marked manner, i.e. up to 70%, in comparison to plant nutrition techniques practiced in the world on different cultivations. This because the elements are totally absorbed by the cultivations without the occurrence of blocks resulting from adverse factors (pH, conductivity, cationic exchange capacity, water availability, etc.). In fact, for the elimination of Ferric Chlorosis on Kiwi, the Iron Humoalginate has been proved to be the fastest agent in the resolution of Iron deficiency and the most persistent since it is not leached away into the stratums, as it occurs on the contrary using synthetic chelating agents (as for example EDTA, EDDHA), which have an elevated environmental impact. It is pointed out, moreover, that the simple combination of leonardite with alginic acid, also in alkaline medium, does not display the same effect as Humoalginates according to the present invention, since the leonardite is totally insoluble in water and the same is true for alginic acid, which in order to display its complexing and protecting activity for humic substances and nutritive elements (both macro and micro) must be necessarily solubilised in alkaline medium. Within fertilizer world-wide market are available both alginates (alginic acid salts) or humates (humic acid salts), which mixed together does not absolutely give the same results as obtained from Humoalginates according to the present invention. In fact, in the latter alginic acid is suitable to complex in the best way both humic substances during the extraction process with the alkaline medium and macro- and/or microelements and/or amino acids and/or plant extracts added to the formulation.

Further, in the present experimentations, Humoalginates allow plants with an enormous root and leaf development to be obtained and prove to be functional also when used in not favourable thermo-igrometric conditions. This means that when known fertilizers do not successfully work, optimal results on the cultivations can be obtained using Humoalginates according to the present invention.
It is therefore a specific object of the present invention a process for the preparation of fertilizer compositions comprising or consisting of the following steps:
a) preparing a muddy mixture of finely ground fossil material in water; using preferably demineralised water,
b) adding under agitation a solution of alginic acid to the muddy mixture from step a) and one or more alkaline agent in proportion between said components and muddy mixture such that
(i) the amount of alginic acid is form 0.50% to 15%, preferably from 0.75% to 4%; and
(ii) the amount of alkaline agent is from 2% to 17%, preferably from 5% to 15%,
said percent being weight percent with respect to total weight of the final mixture obtained from step b),
c) maintaining the mixture under stirring up to complete homogenization of the mixture.

Preferably, in step b), the solution of alginic acid and one or more alkaline agents is added in a percentage variable from 5 to 20 weight % with respect to total weight of the final mixture; said solution comprising or consisting of alginic acid from 15 to 20 weight % and one or more alkaline agents from 80 to 85 weight %.

In the present description “fossil material” means a material comprising at least 60% of total organic substance, i.e. an organic carbon source of biological origin where at least 60% of such organic substance proves to be extractable or hunified. In particular, the fossil material suitable for the practice of the present invention comprises at least 80%, preferably at least 90%, of total organic substance, where at least 80%, preferably at least 90%, of such organic substance proves to be extractable or hunified. The fossil material is preferably selected from the group consisting of leonardite, lignite, xylite, hunified peat, coal peat and mixtures thereof. Leonardite is the preferred fossil material for the practice of the present invention.

Therefore, using the process according to the present invention it is obtained a fertilizer composition containing the reaction product of alginic acid with humic and/or fulvic acids contained in the fossil material and which are extracted from the alkaline agent resulting in the formation of complexes below named Humoalginates.

Preferably, the fossil material used in the process is in a finely ground form with a particle size from impalpable grinding (that is as fine as possible), in order to secure the highest extraction of humic acids, to 400 μm, preferably from 20 to 400 μm, still more preferably from 100 to 150 μm for the preparation of solid formulations and from impalpable grinding to 50 μm for the preparation of liquid formulations, preferably from 20 to 50 μm.

In the practice of the present invention, the amounts of the fossil material and water in the step a) are preferably variable from 1:0,3 to 1:6 weight parts.

The water employed in the phase a) is preferably demineralised water.

The alginic acid is a natural acid consisting of a very stable polyuronic complex and mostly containing D-mannuronic and L-guluronic acid chains.

The alkaline agent preferably is selected from the group consisting of potassium hydroxide, ammonium hydroxide or combination thereof. Preferably these alkaline agents are expressed respectively, like 48-50% potassium hydroxide solution 48-50% or in pure form as pellets dissolved in demineralised water at desired concentrations or 28° Be grade ammonium hydroxide.

It is moreover preferable to carry out the stirring of the kneading for 6-12 hours, or to bring out the production with a continuous plant allowing to obtain the homogenization of the whole mass and optimize industrially the production.

According to a preferred embodiment of the process of the present invention, to the mixture of the fossil material, preferably leonardite, in the step a) or in combination to the final composition, in this latter case when the formulation is liquid, one or more substances selected from the group consisting of macroelements, microelements, animal or vegetal protein hydrolyzates, vegetal extracts with insecticidal, nematicidal or fungicidal activities, phyto-regulating agents, fertilizer agents, are added. Particularly the macroelements can be polyphosphates, phosphates, potassium salts, magnesium salts, calcium salts. The microelements are, for example, iron salts, manganese salts, copper salts, boron compounds, molybdenum compounds, zinc salts.

The amount of macroelements and\or microelements that can be employed is lower than 60% by weight with respect to total weight of the fertilizer composition. Among other substances potentially added to the compositions of the present invention protein hydrolysates of animal or the vegetal origin as for example fluid suspended carniccio (leather production by-product), vegetal amino acid complexes, hormonal substances as for example auxins, gibberellines and cytokynines, vegetal extracts with insecticidal, nematicidal activities, in amounts lower than 60% by weight with respect to total weight of the composition, as for example vegetal oil-cakes obtained from the extraction of castor (ricinus communis), neem (azadiracta indica) and\or karanja (pongamia glabra) oils, or neem oil or karanja oil, can be mentioned.

Some preferred embodiments of the present invention are represented by Humoalginates of nitrogen, Humoalginates of nitrogen and phosphorus, nitrogen, phosphorus and potassium, iron, boron, calcium and magnesium, vegetal extracts, amino acids, microelements, molybdenum, zinc and manganese. Therefore, Base Humoalginate, formulated exclusively by extracting humic acids from Leonardite or other fossil hunified material, is a very concentrated with high content of organic carbon, which, on the other hand, does not contain neither macro nor microelements added during the extraction process of humic substances. This base product, that will be used in industrial processes for the formulation of mixed preparations with macro and/or microelements and/or vegetal extracts, and/or amino acids of animal and/or vegetal origin, can also be used by agricultural workers alone when it is necessary to quickly restore the fertility of an exhausted, impoverished soil or soil with elevated salinity resulting from the indiscriminate chemical fertilizer use or irrigation waters. Moreover, base Humoalginate can be used by the worker as a mixture with complex or simple mineral fertilizers. Complex Humoalginate is a fertilizer wherein, before the extraction of the humic substances, macro and/or microelements have been added in order to generate nutritive complexes with variable titer as a function of the type and percentages of added elements. Alternatively, to the base Humoalginate macro and/or microelements and/or other ingredients can be added in order to obtain titered formulations to be specifically used according to the cultivation or phenological phases.

The present invention concerns, moreover, the use of Alginic Acid, regardless of used percentages, for the preparation of fertilizer or surfactant compositions comprising humic extracts and/or humic derivatives, resulting from hunified fossils as for example Lignite, Leonardite, Xylite, Coal Peat, hunified Peat

When a fertilizer composition in solid form is desired, the kneading resulting from the mixture of fossil material, preferably leonardite, and water, preferably demineralised water, to which alkaline agent and alginic acid in the appropriate percentages are added, is subjected to granulation and drying steps. Such operations can be carried out in any order or at the same time, depending on the case requirements and knowledge of the technician of the art. As an example, the process of the present invention can be practiced by means of an online plant involving the carrying out of the all working steps and the delivery of thus obtained mixture to a system for granulation or pelletizing or drying (for example by means of rotating dryers) or specific granulators, in order to obtain a continuous, working cycle indispensable to obtain the industrialization and optimization of the present invention. The process of the present invention can be moreover practiced according to other technologies which those skilled in the art will select opportunely according to the case requirements and allowing the online introduction of various components to be carried out while the system effects the homogenization of all the mass, so as to obtain directly, the mixture in pellet granular or microgranular form to be localized for example on cultivation rows at sowing time or on growing cultivations.

The process of the present invention comprises, preferably, again when the preparation of a fertilizer composition in solid form is desired, the addition to the mixture under stirring and up to complete homogenization of at least a source of nitrogen and\or potassium in amount of 30-60% by weight with respect to total weight of the fertilizer composition. In the present disclosure the term fertilizer source of nitrogen, phosphorus and\or of potassium means a substance or complex releasing said elements in the corresponding bio-available forms. In particular, the source of nitrogen, phosphorus and/or potassium is selected from the group consisting of urea, polyphosphates, phosphates, carbonates, thiosulphates and like. On the other hand when the preparation of a fertilizer composition in liquid form is desired, the process of the present invention comprises the separation of the liquid phase from the insoluble fraction of the mixture, wherein the liquid phase constitutes the liquid fertilizer composition. In this specific case, it is preferable the use of fossil material having a mean particle size from 20 to 40 μm. Moreover, it is preferable to carry out the separation of the liquid phase from the insoluble fraction of the mixture by means of appropriate filtration system. Specifically, when the preparation of a liquid fertilizer composition of base Humoalginate is desired, which will be used in order to prepare fertilizer and/or surfactant compositions in industrial scale, in addition to be used such it is when it is necessary to provide for high content of humic substances, with system under stirring, in hermetic reactor equipped with propeller stirring system adjustable as to speed and rotation sense, water, preferably demineralised water, fossil material, preferably finely ground leonardite are added and only successively the alkaline agent opportunely chosen from potassium hydroxide and ammonium hydroxide or mixture thereof wherein alginic acid has been dissolved, is added. Generally water is in amount higher than 60%, while fossil material is preferably in amount of 20%, generally from 15 to 25% by weight with respect to total weight of the mixture obtained in the phase b), that is treated mixture. The resulting mixture is maintained under high stirring, preferably for 3 hours. The percentages of alginic acid are from 0,75% to 4% by weight with respect to total weight of the mixture obtained in the phase b), while the alkaline agent is from 4 t17% by weight with respect to total weight of the mixture obtained in the phase b).

The resulting mixture is filtered through 20-40 μm pore size, so as to allow directly the use of said composition in the fertirrigation systems used in the agricultural farms and/or for washing of polluted soil s.

As a result of numerous field experimentations on fruit and vegetable, ornament or grassy carpet cultivations, it has been found that the compositions of the present invention display high chelating activity allowing macro and microelements to be easily bound. The complexes obtained and delivered by using the compositions of the present invention prove, moreover, to be difficulty separable, resulting in an elevated functionality both of the organic and mineral fraction, in addition to an exceptional stability of the formulations according to the present invention in different pedoclimatical conditions.

As a result of using the compositions of the present invention, a remarkable increment of the productions with a remarkable acceleration of all the biochemical functions in the plants and soil has been found out. The compositions of the present invention are rapidity acting and display an elevated both chemical and biological efficiency as soon as they are applied to the soil or administered on leaf apparatus of the plant due to the fact that the several nutritive components are protected by a strong humic binding. The compositions of the present invention moreover allow very important physical benefits to be observed like for example increase of the water retention of soil with irrigation water savings up to 40%, increase of soil aeration, improvement of soil cultivability, higher resistance to drought, reduction of soil erosion phenomena, improvement of the general texture. Remarkable chemical benefits are further observed since the compositions of the invention make the inorganic fertilizers water soluble in the zones of radical apparatus of the plant, ready to be used as need, requires, promote the conversion of many elements in plant available forms, increasing the cationic exchange capacity, participate to the decomposition of rock, minerals and noxious substances occurring in the soil, chelate strongly binding the nutritive elements they are combined with, delivery high organic carbon titers with elevated humification degree preventing any leaching of soil occurring nitrogen, reduce the impoverishment of agrarian soils subjected to the mono-cultivation, reclaim treated soil acting as excellent natural surfactants for washing of soils with elevated pollution index. The compositions according to the present invention, in fact, allow a fast restoration of the normal biochemical conditions and fast cultivation of the same. The biological benefits are numerous since the compositions of the invention stimulate the growth of the plants, accelerating the cellular division with increase of seed germination power of the seeds enhancing the development of seedlings, increasing the vitamin content of the plants and fruits, increasing the permeability of the cellular membrane of the plants. In fact, the compositions of the invention promote the absorption of the nutritive substances, stimulate the development of roots, especially in longitudinal way, stimulate the development and proliferation of useful microorganisms in the soil, enhance the activity of the chlorophyll photosynthesis upgrading in meaningful way endogenous protection, with increase of all the biochemical activities of the soil, display a strong activity as organic catalyst and allow the reduction up to 70% of the fertilizing units used in the present techniques of cultivation fertilization. Therefore, the compositions of the invention allow the complete elimination of using the synthetic chelating (EDTA, DTPA, EDDHA etc) agents present in the currently commercially available formulations which result in very high environmental impact since immediately are leached into the stratums and consequently accumulated in waters and foods, designed for animal and human feeding. In fact, the compositions according to the present invention have a very high chelating and deficient condition resolving power without to provoke any leaching of used synthetic chelating agents including nitrate hyper-accumulation in the stratums and foods.

The present invention now be described by illustrative, but not limitative way, according to preferred embodiments thereof.

### EXAMPLE 1

### Base Humoalginate as a Liquid Formulation

Base Humoalginate can be used such it is as a fertilizer (amendant) with high content of humic acids and/or as mixtures with mineral fertilizers and/or for the preparation of complex or simple fertilizers based on macro and microelements, vegetal extracts, amino acids of various origin and for washing of polluted soils. The composition of base Humoalginate is prepared by mixing the following components as above described:

a) 70% Demineralised water;
b) 20% Leonardite with biological origin organic Carbon content of 48%;
c) 10% as an alkaline solution consisting of: 85% of 28Be ammonium hydroxide and 15% of Alginic Acid

The titration of the formulated product that will be commercialized as LIQUID BASE HUMOALGINATE results in an ORGANIC CARBON content of 9.6% by weight.

### EXAMPLE 2

### Nitrogen Humoalginate as a Liquid Formulation

The composition of nitrogen Humoalginate is prepared by mixing the following components as above described:

### a) 25.0% DEMINERALISED WATER

b) 43.5% TECHNICAL UREA containing 46% UREIC NITROGEN

### c) 31.5% LIQUID BASE HUMOALGINATE

In a tank equipped with stirring system, preferably with propellers, the water, preferably demineralised, is poured and with the system under stirring the urea and successively the base liquid Humoalginate are added; the mixture is maintained under agitation up to the complete dissolution of all added urea.

The titration of the formulated product that will be commercialized as LIQUID NITROGEN HUMOALGINATE shows the following result:

### UREIC NITROGEN 20%

### ORGANIC CARBON 3%

### EXAMPLE 3

### NPK Humoalginate 3-15-3 0.1% B+0.1% Mn+0.1% Zn as a Solid Formulation

The composition preferably is prepared in form of micro-granules with diameter from 0,6 to 1 mm, to be localized on the rows during the sowing, by mixing the following components as above described:

### a) 25% MONOAMMONIUM PHOSPHATE (MAP) 12-61

b) 61.79% FINELY GROUND LEONARDITE (as dried substance)

### c) 12% ALKALINE SOLUTION CONSISTING OF 80% POTASSIUM HYDROXIDE AS 48% SOLUTION AND 20% ALGINIC ACID

### d) 0.6% BORIC ACID (BORON 17.5%)

### e) 0.32% MANGANESE SULFATE (Mn 32%)

### f) 0.29% ZINC SULFATE (Zn 35%)

### g) DEMINERALIZED WATER q.b.

The water Is used in order to create the muddy mixture between leonardite, mono-ammonium phosphate, boric acid, manganese sulfate, zinc sulfate, before the addition of the alkaline solution in which it has been solubilised alginic acid. The water, evaporated at dryness, is not calculated in the final composition. Moreover, eventual water contributions with raw materials (as an example with the alkaline solution) must be compensated with the addition of identical amount of Leonardite or other fossil material used in the preparation.

This type of fertilizer will come commercialized with the following label:

### 3% TOTAL NITROGEN

Of which:

### 3% AMMONIACAL NITROGEN

### 15% PHOSPHORIC ANHYDRIDE P₂O₅

### 3% POTASSIUM OXIDE K₂O

### 0.1% BORON (B)

### 0.1% MANGANESE (Mn)

0.1% ZINC (Zn)

1. Process for the preparation of fertilizer compositions comprising or consisting of the following steps:
a) preparing a muddy mixture of fossil material in water;
b) adding under agitation a solution of alginic acid to the muddy mixture from step a) and one or more alkaline agent in proportion between said components and muddy mixture such that
(i) the amount of alginic acid is from 0.50% to 15%, preferably from 0.75% to 4%; and
(ii) the amount of alkaline agent is from 2% to 17%, preferably from 5% to 15%,
said percent being weight percent with respect to total weight of the final mixture obtained from step b),
c) maintaining the mixture under stirring up to complete homogenization of whole kneading.

2. Process according to claim 1, wherein in step b) the solution of alginic acid and one or more alkaline agent is added in a percentage ranging from 5% to 20% by weight relative to the total weight of the final mixture, said solution comprising or consisting of alginic acid from 15 to 20 weight % and one or more alkaline agents from 80 to 85 weight %.

3. Process according to claim 1, wherein the final mixture is under stirring for at least 3 hours, preferably 6 hours, or continuously processed.

4. Process according to claim 1, wherein the fossil material is chosen from the group consisting of leonardite, lignite, xylite, hunified peat, coal peat and mixtures thereof.

5. Process according to claim 1, wherein the fossil material is in finely ground form with particle size from 20 to 400 μm.

6. Process according to claim 5, wherein the particle size is from 20 to 50 μm for the preparation of liquid formulations and from 100 to 150 μm for the preparation of solid formulations

7. Process according to claim 1, wherein fossil material and water amount ratio in step a) is from 1:0,3 to 1:6 w/w.

8. Process according to claim 1, wherein the alkaline agent is chosen from the group consisting of potassium hydroxide or ammonium hydroxide and mixture thereof.

9. Process according to claim 1, wherein one or more substances, chosen from the group consisting of macroelements, microelements, animal or vegetal protein hydrolyzates, vegetal extracts with insecticidal, nematicidal or fungicidal activities, phyto-regulating agents, fertilizer agents, are added to the fossil material in step a) or in association to the final composition.

10. Process according to claim 1, wherein the mixture obtained in step c) is subjected to granulation and drying in order to obtain a fertilizer composition in solid form.

11. Process according to claim 1, wherein the mixture obtained in step c) is subjected to filtration in order to separate the liquid fertilizer phase.

12. Fertilizer composition in solid form obtainable according to the process of claim 1.

13. Fertilizer composition in liquid form obtainable according to the process of claim 1.

14. Use of the compositions according to claim 1, as fertilizer.

15. Use of the compositions according to claim 1, as natural surfactants for the washing, reclamation and cultivation of contaminated soils.

16. Use of alginic acid for the preparation of fertilizer or surfactant compositions comprising humic extract and/or humic derivatives, from hunified fossil materials.
